(19) United States
(12) Patent Application Publication
(10) Pub. No.: US 2010/0146240 A1
(43) Pub. Date: Jun. 10, 2010

(54) Method, Application System and Storage Device for Managing Application Configuration Information

(75) Inventor: Huaqiang Hu, Guangzhou City (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: H3C TECHNOLOGIES CO., LTD., Hangzhou (CN)

(21) Appl. No.: 12/550,236

(22) Filed: Aug. 28, 2009

(30) Foreign Application Priority Data
Dec. 5, 2008 (CN) 200810239051.4

(51) Int. Cl. G06F 12/00; G06F 17/00

(52) U.S. Cl. 711/202

(57) ABSTRACT

The present invention provides a method, an application system and a storage device for managing the configuration information of applications, and it is applied to the storage device where an application extension area is created for every logical resource and their application extension area to physical resource mappings are maintained. The method comprises: the application system accessing the application extension area of a logical resource on the storage device when executing an application; the storage device storing the configuration information generated by the application system for the application to the appropriate physical resource based on the said mappings. The present invention ensures that the configuration information of applications can survive the failure of the application system or storage device and be restored when the application system or the storage device recovers.

### TECHNICAL FIELD

The present invention relates to computer communications technology and, more particularly, a method, an application system and a storage device for managing application configuration information in the computer network storage field.

### BACKGROUND

In the network storage field, a storage device generally comprises a storage controller, or a storage controller, hard disk arrays, and optionally, other components. The front end of a storage device communicates with hosts in a network through network interfaces (FC interfaces or Ethernet interfaces) to provide storage services. To hide the physical differences among storage media and provide storage media users with unified, robust, manageable storage spaces, storage media virtualization was introduced. Storage media virtualization maps accesses to logical resources to appropriate physical resources by using a storage virtualization component. This requires that the storage virtualization component maintain mappings between logical resources and physical resources. In addition, the mappings must be stored not only in the configuration file of the storage device but also on the physical resources to ensure that the logical resources could be re-created based on the mappings in case the physical resources are moved to other storage devices after the storage device fails for example.

Virtualization greatly improves user experience, and provides better services for upper-layer applications. With current technologies, if an application system needs to execute an application on a storage device to copy data for example, the application system must generate and store the configuration information of the application on itself in order to perform operations on the storage device. Generally, an application system is located at the upper layer of the virtualization component. It may be integrated in the storage device, or run on user PCs. An application system generally comprises various applications, such as data backup application and snapshot application. As shown in FIG. 1, when copying data on the storage device, the application system generates and stores the configuration information of the application in itself. The application configuration information can be the source device, destination device, application ID, and operation type. Then, the application system accesses the appropriate logical resource data area maintained by the storage virtualization component according to the configuration information, and the storage virtualization component maps the access to the logical resource data area to the appropriate physical resource according to the segment mapping table of the logical resource.

With the current technologies, application configuration information is stored in the application system, which may be lost when the application system fails. Loss of configuration information will result in the incapability of recovering application operations, even if the logical resource data areas on the storage device are still accessible. In addition, the incapability of application operation recovery can result if the physical resources are moved to another storage device (the destination device) after the current storage device fails for example. This is because the application configuration information is associated with the source storage device, and the application system cannot re-associate the information with the destination storage device.

### SUMMARY OF THE INVENTION

The present invention provides a method, an application system and a storage device for managing application configuration information, which addresses the problem that application operations cannot be recovered after a failed application system or storage device recovers.

This method for managing application configuration information applies to the storage device where an application extension area is created for every logical resource and their application extension area to physical resource mappings are maintained, wherein,

the application system accesses the application extension area of a logical resource on the storage device when executing an application, and the storage device stores the application configuration information to the appropriate physical resource based on the application extension area to physical resource mappings of the logical resource.

The application system comprises an application execution unit, and a logical resource access unit that comprises a data area access sub-unit, wherein the logical resource access unit further comprises an application extension area access sub-unit;

the application execution unit is used to execute applications and generate application configuration information;

the application extension area access sub-unit is used, when the application execution unit executes applications, to access logical resource application extension areas created in advance by the storage device, and to provide the application configuration information generated by the application execution unit for the storage device to store in the physical resources assigned to the logical resource application extension areas.

The storage device comprises a storage virtualization component that comprises a logical resource creation unit, a mapping table storage unit and an access mapping unit, wherein

the logical resource creation unit is used to create the application extension areas of logical resources.

The mapping table storage unit is used to store application extension area to physical resource mappings for logical resources in their segment mapping tables.

The access mapping unit is used to map the application system's accesses to logical resource application extension areas to the appropriate physical resources according to the segment mapping tables of logical resources, and to store the application configuration information generated by the application system onto the physical resources mapped to the logical resource application extension areas.

As described above, with the method, the application system and the storage device of the present invention, an application extension area is created in advance for every logical resource, and their application extension area to physical resource mappings are stored in the storage device. When the application system executes an application, it accesses the application extension area of the appropriate logical resource. The storage device stores the application configuration information generated by the application system in the appropriate physical resource according to the application extension area to physical resource mappings of the logical resource. As the application configuration information is stored together with data in physical resources, it can survive the failure of the application system, and when the physical resources are moved to another storage device after the current storage device fails, move together with the physical resources and automatically associate with the target storage device. With the application configuration information, the application system can recover the application operations after it or the storage device recovers from a failure.

### DESCRIPTION OF THE DRAWINGS

FIG. 1 is a schematic diagram illustrating how an application is executed with the current technologies.

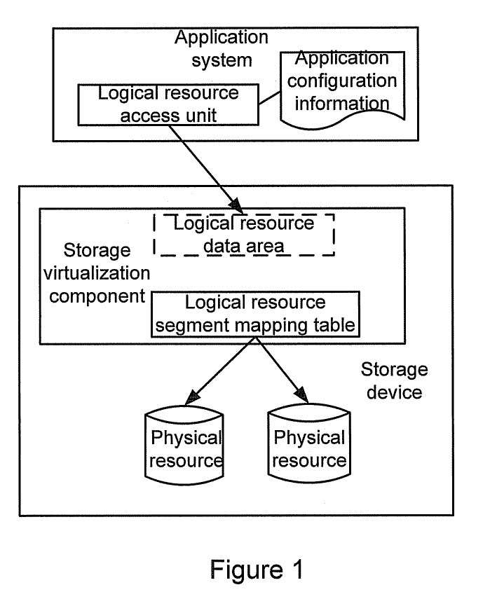

FIG. 2 is a schematic diagram illustrating how an application is executed in accordance with an embodiment of the present invention.

FIG. 3 is a schematic diagram illustrating the virtualized information structure of physical resource in accordance with an embodiment of the present invention.

FIG. 4 is a flow chart illustrating how a logical resource is created in accordance with an embodiment of the present invention.

FIG. 5 is a flow chart illustrating how the application extension area of a logical resource is recovered in accordance with an embodiment of the present invention.

FIG. 6 is a schematic diagram illustrating the system structure in accordance with an embodiment of the present invention.

### DETAILED DESCRIPTION OF THE INVENTION

To clarify the aims, technical proposals, and advantages of the present invention, the following part describes the present invention in detail in conjunction with the figures and embodiments.

The method provided by the present invention comprises: creating an application extension area for every logical resource and storing application extension area to physical resource mappings for the logical resources on the storage device; the application system accessing the application extension area of a logical resource when executing an application, and the storage device storing the application configuration information generated by the application system on the appropriate physical resource according to the application extension area to physical resource mappings of the logical resource.

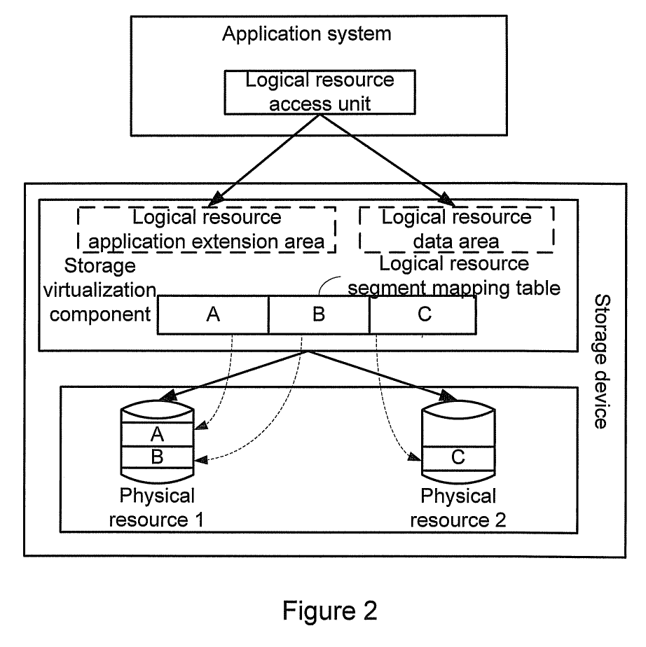

FIG. 2 is a schematic diagram illustrating how an application is executed with the present invention. As shown in FIG. 2, for a logical resource, the storage virtualization component creates an application extension area in addition to a data area. The segment mapping table of the logical resource comprises both data area to physical resource mappings and application extension area to physical resource mappings. When the application system accesses the application extension area of the logical resource in order to execute an application, the storage virtualization component maps the access to the appropriate physical resource to store the configuration information of the application on the physical resource. Part A in the segment mapping table of the logical resource in FIG. 2 stores an application extension area to physical resource mapping, and it maps the application extension area to portion A of physical resource 1; parts B and C in the segment mapping table store data area to physical resource mappings, and they map the data area to portion B in physical resource 1 and portion C of physical resource 2.

With the present invention, storage device virtualization starts with creating logical resources. Creating a logical resource comprises creating a data area and an application extension area. Wherein, the data area can be created with the current technologies. The following is focused on how to create the application extension area of a logical resource.

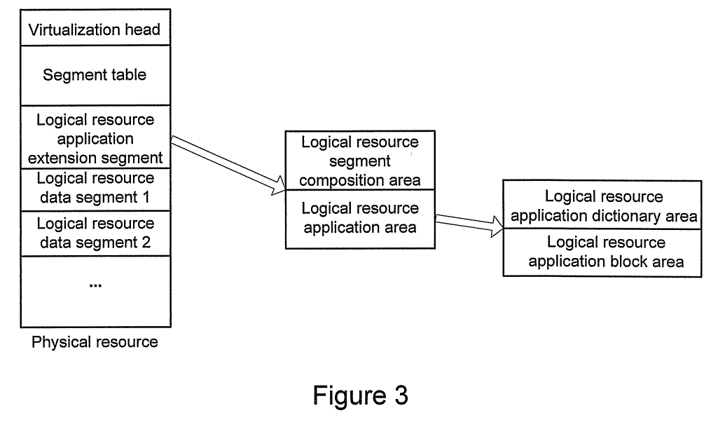

To help understand the method, the following describes the virtualized information structure of physical resources. FIG. 3 is a schematic diagram illustrating the virtualized information structure of physical resources in accordance with an embodiment of the present invention. As shown in FIG. 3, every physical resource comprises:

A virtualization head at the top, which is used to identify whether the physical resource has been virtualized by the storage virtualization component. The head may comprise the virtualization magic number indicating whether the physical resource has been virtualized, location and size of the physical resource's segment table, and also cyclic redundancy check (CRC) data.

A segment table, which records the physical segments allocated to logical resources, that is, to the data areas and application extension areas of logical resources. The storage virtualization component can use the segment table to manage spaces of physical resources and to identify the assigned and free spaces of physical resources. The segment table may record information about the data and application extension segments of logical resources, describing their segment type, location, and size.

Logical resource application extension segments, a new type of physical segment introduced by the present invention, divided into a segment composition area and an application area for every logical resource. The segment composition area for a logical resource records the physical resource information of the logical resource, including the ID, location and size of the logical resource application area, and ID, location and size of corresponding logical resource data segments. The storage virtualization component builds the segment mapping portion for the application extension area, that is, part A in the segment mapping table of the logical resource (as shown in FIG. 2) according to the contents in the logical resource application extension segments. The logical resource application area is used to store application configuration information for a logical resource, and it can be divided into an application dictionary area and an application block area. The application dictionary area is used to store dictionary-structure configuration information, such as quartets of application ID, application keyword, application configuration information, and configuration information length. The application block area is used to store configuration information in blocks, such as configuration information in tables. Of course, the logical resource application block area can be used as a whole without division.

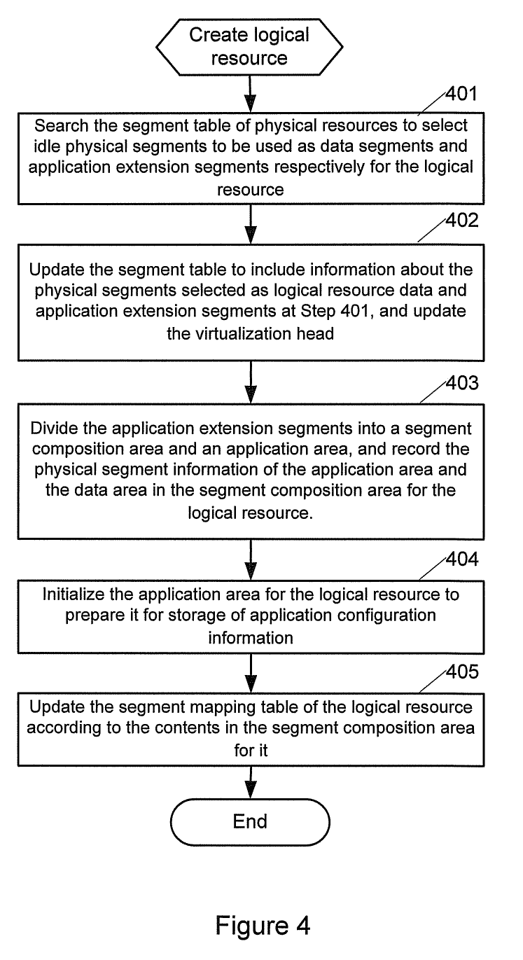

The following describes in detail how to create a logical resource according to the virtualized information structure as shown in FIG. 3. FIG. 4 is a flow chart illustrating how a logical resource is created in accordance with an embodiment of the present invention. As shown in FIG. 4, the process is as follows:

Step 401: Search the segment table of physical resources to select idle physical segments to be used as data segments and application extension segments respectively for the logical resource.

The segment table of a physical resource can be used for selecting data segments and application extension segments for a logical resource because the table records the segment assignment status of the physical resource. The spaces of the selected data segments and application extension segments can be specified and selected by users or automatically assigned according to the pre-defined size.

Step 402: Update the segment table to include information about the physical segments selected as logical resource data and application extension segments at Step 401, and update the virtualization head.

Updating the segment table according to the result at Step 401 further comprises marking the physical segments selected as the data and application extension segments of the logical resource as used spaces, and recording their location and size.

Step 403: Divide the application extension segments into a segment composition area and an application area, and record the physical segment information of the application area and the data area in the segment composition area for the logical resource. The process of creating a data area for a logical resource is omitted.

At this step, the application extension segments selected for the logical resource are divided into a segment composition area and an application area. Wherein the space assigned to the segment composition area must meet the minimum space requirement, which is either user specified or automatically assigned in accordance with the pre-set space size in the system. The application area for a logical resource is used to store configuration information and can be further divided into an application dictionary area and an application block area. After the division, the physical segment information of the application area, such as its ID, location and size, is recorded in the segment composition area.

Step 404: Initialize the application area for the logical resource to prepare it for storage of application configuration information.

Step 405: Update the segment mapping table of the logical resource according to the contents in the segment composition area for it.

With the present invention, the segment mapping table that the storage virtualization component maintains for a logical resource comprises not only data area to physical resource mappings, but also application extension area to physical resource mappings. Wherein, creating data area to physical resource mappings is done with the current technologies and thus is not described in this document. As for application extension area to physical resource mappings, they are generated according to the contents (physical segment information of the application area for the logical resource) recorded in the segment composition area after the logical resource is generated. Thus, the application extension area of the logical resource is mapped to the application area for the logical resource on a physical resource.

By now, the application extension area of the logical resource is created.

After the application extension area of a logical resource is created, it can be accessed when the application system executes an application. Based on the application extension area to physical resource mappings of the logical resource, the storage virtualization device maps the access to the appropriate physical resource to store the application configuration information generated by the application system in the application area for the logical resource.

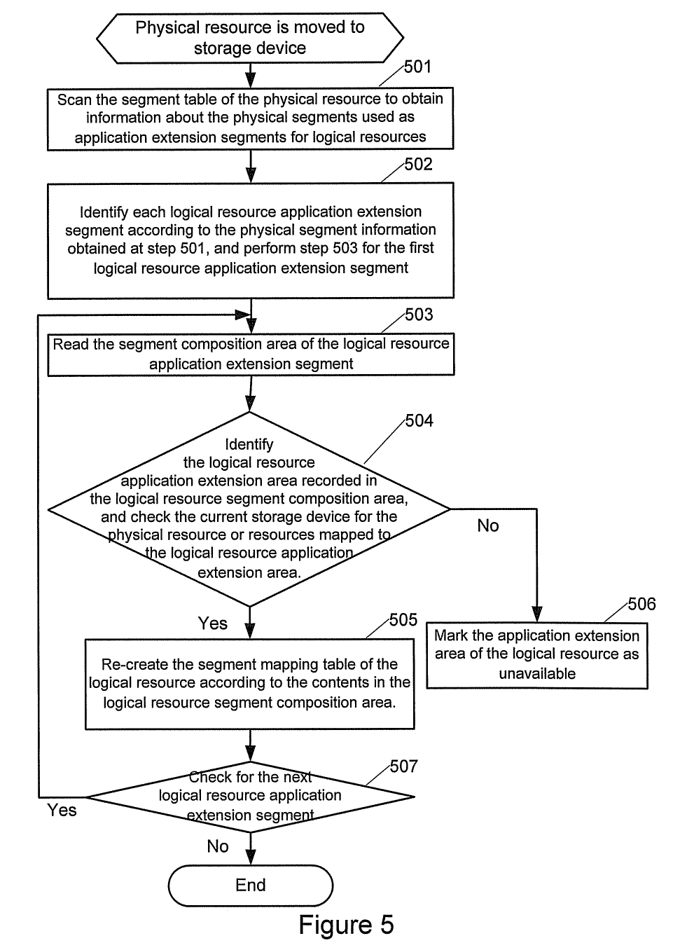

If the storage device fails and the physical resources are moved to another storage device, the storage virtualization component in the destination storage device can recover the application extension area of every logical resource created on the physical resources. Because the application extension area of a logical resource stores the original configuration information of applications, the storage virtualization device can re-associate the configuration information and the data in the data area of the logical resource after the application extension area is recovered. FIG. 5 illustrates how the application extension area of a logical resource is recovered on the destination storage device. On each physical resource, the following steps are performed:

Step 501: Scan the segment table of the physical resource to obtain information about the physical segments used as application extension segments for logical resources.

Wherein the location and size information of each physical segment whose segment type is logical resource application extension segment is obtained.

Step 502: Identify each logical resource application extension segment according to the physical segment information obtained at step 501. Proceed to perform step 503 for the first logical resource application extension segment.

Step 503: Read the segment composition area of the logical resource application extension segment.

Step 504: Identify the logical resource application extension area recorded in the logical resource segment composition area, and check the current storage device for the physical resource or resources mapped to the logical resource application extension area. If they are found, proceed to step 505; otherwise, proceed to step 506.

Step 505: Re-create the segment mapping table of the logical resource according to the contents in the logical resource segment composition area.

Step 506: Mark the application extension area of the logical resource as unavailable, and proceed to step 507.

Step 507: Check for the next logical resource application extension segment. If one is found, return to step 503 for this logical resource application extension segment; otherwise, the procedure ends.

During the above procedure, it is also required to check the destination storage device for the logical resource data segments, that is, the physical resources mapped to the data area of the logical resource, recorded in the logical resource segment composition area. If they are not found, mark the data area of the logical resource as unavailable. If either the application extension area or the data area is unavailable, the logical resource is marked unavailable.

If the application system accesses the application extension area of an available logical resource recovered as described above when executing an application, the storage virtualization component maps the access to the appropriate physical resource. The application system can then search the logical resource's application area on the physical resource by the ID of the application, associate the application with the configuration information entry found containing the application ID, and execute the application using the associated configuration information. Wherein, the application ID can comprise the source resource, destination resource, and operation type ID of the application.

When the application system recovers from a failure to execute an application, it accesses the application extension area of the appropriate logical resource on the storage device. The storage device maps the access to the appropriate physical resource where the configuration information of the application has been stored. The application system can then search the logical resource application area on the physical resource by the ID of the application, associate the application with the configuration information entry found containing the application ID, and execute the application using the associated configuration information.

Suppose the application system is to perform a copy data application after it or the storage device recovers from a failure. The application system first accesses the application extension area of the appropriate logical resource on the storage device, which maps the access to the appropriate physical resource where the configuration information of the application has been stored. The application system searches the logical resource application area on the physical resource by the ID of the copy application for the configuration information entry containing the copy application ID. If the entry is found and the operation type is copy, and the destination resource and source resource are consistent with those of the application, the application system associates the configuration information with the application, and executes the application.

Preferably, the execution progress status of an application is included in its configuration information. Thus, after the application or the storage device recovers from a failure, the application can continue from where it stops. For example, the progress status information of the copy application is stored in its configuration information entry. In the event that the application fails, the application system can execute the application to copy data from where it stops after the application recovers by using the execution progress status information.

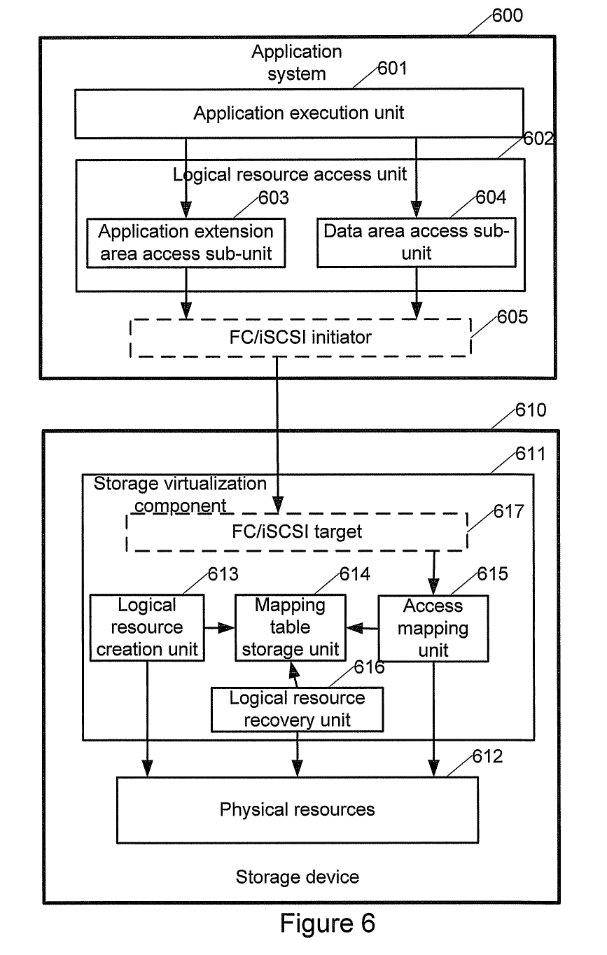

The above describes the method provided by the present invention, and the following describes in detail the system and device provided by the present invention. FIG. 6 is a schematic diagram illustrating the system structure of an embodiment in accordance with the present invention. As shown in FIG. 6, the system comprises: application system 600, and storage device 610 where logical resource application extension areas are created and mappings between logical resource application extension areas and physical resources are stored in advance.

Application system 600 is used to access logical resource application extension areas in storage device 610 when applications are executed.

Storage device 610 is used to store the configuration information generated by application system 600 for executed applications onto appropriate physical resources based on the mappings between logical resource application extension areas and physical resources.

The following describes application system 600 and storage device 610 in detail. Application system 600 comprises: application execution unit 601, and logical resource access unit 602, which further comprises application extension area access sub-unit 603 and data area access sub-unit 604.

Application execution unit 601 is used to execute applications and generate application configuration information.

Application extension area access sub-unit 603 is used, when application execution unit 601 executes an application, to access the application extension area of the appropriate logical resource on storage device 610, and to deliver the application configuration information generated by application execution unit 601 to storage device 610.

Wherein application extension area access sub-unit 603 delivers the application configuration information to storage device 610 to store in the application extension area of the logical resource by calling the application programming interface (API) library.

Data area access sub-unit 604 is used to access the logical resource data area on storage device 610 when application execution unit 601 executes the application.

The description of data area access sub-unit 604 is omitted because it has been implemented with the current technologies in logical resource access unit 602 and no functionality changes are made.

Application extension area access sub-unit 604 in the application system is also used to search the logical resource application area by the application ID and associate the application with the configuration information entry found containing the application ID after application system 600 or storage device 610 recovers from a failure.

After application system 600 or storage device 610 recovers from a failure, application extension area access sub-unit 603 only accesses the application extension areas of available logical resources and searches the corresponding logical resource application areas. A logical resource is considered available only when both of its application extension area and data area are available.

An application ID can comprise the source resource, destination resource, and operation type ID of the application.

Application execution unit 601 is also used to execute the application by using the application's configuration information found by the application extension area access sub-unit 603.

Moreover, if the application system and the storage device are co-located, application extension area access sub-unit 603 and data area access sub-unit 604 can directly access logical resources. If the application system is on the client, application extension area access sub-unit 603 and data area access sub-unit 604 accesses logical resources through Fiber Channel or Internet Small Computer System Interface (iSCSI). In this case, the application system typically comprises FC/ISCSI initiator 605, and storage virtualization component 611 comprises FC/ISCSI target 617 to implement protocol conversion. Description of this part is omitted because it is implemented with the current technologies.

Preferably, the application configuration information comprises application execution progress status information so that application execution unit 601 can continue to execute an interrupted application from where it stops after the application resumes.

Application execution unit 601 and logical resource access unit 602 in application system 600 can be designed as two separate units or one integrated unit.

The following describes storage device 610 in detail. Storage device 610 can comprise storage virtualized component 611, which further comprises logical resource creation unit 613, mapping table storage unit 614, and access mapping unit 615.

Logical resource creation unit 613 is used to create an application extension area for every logical resource.

Mapping table storage unit 614 is used to store application extension area to physical resource mappings in the segment mapping table of a logical resource.

Access mapping unit 615 is used to map the access of application system 600 to the application extension area of a logical resource to the appropriate physical resource according to the segment mapping table of the logical resource, and to store the application configuration information generated by application system 600 onto the physical resource.

That logical resource creation unit 613 creates the application extension area of a logical resource can comprise: searching the segment table of physical resources to select the idle physical segments to be used as the data segment and application extension segment respectively for the logical resource, and recording information about the selected segments in the segment table; dividing the application extension segments into a segment composition area and an application area, and recording the physical segment information of the application area in the segment composition area (the application area is used to store application configuration information); initializing the application area, generating application extension area to physical resource mappings according to the contents in the segment composition area, and delivering the mappings to mapping table storage unit 614.

Storage virtualized component 611 can further comprise logical resource recovery unit 616, which is used to recover logical resource application extension areas for newly immigrated physical resources. Wherein, logical resource recovery unit 616 scans the segment table of the physical resources for the physical segment information of logical resource application extension segments, identifies logical resource application extension segments according to the obtained physical segment information, and for each logical resource application extension segment, reads the logical resource segment composition area to identify the logical resource application extension area and determines whether the physical resources mapped to the logical resource application extension area exist in storage device 610. If yes, mappings between the logical resource application extension area and the physical resources are created according to the contents in the logical resource segment composition area and delivered to the mapping table storage unit; otherwise, the logical resource application extension area is marked unavailable.

Mapping table storage unit 614 is also used to re-create segment mapping tables for logical resources according to the mappings provided by logical resource recovery unit 616.

In addition, the storage device can also comprise hard disk arrays containing physical resource 612.

As described above, with the method, the application system and the storage device of the present invention, an application extension area is created in advance for every logical resource in the storage device, and their application extension area to physical resource mappings are stored. When the application system executes an application, it accesses the application extension area of the appropriate logical resource on the storage device. The storage device, according to the application extension area to physical resource mappings for the logical resource, stores the configuration information of the application generated by the application system to the appropriate physical resource. As the application configuration information is stored together with data in physical resources, it can survive the failure of the application system, and when the physical resources are moved to another storage device after the current storage device fails, move together with the physical resources and automatically associate with the target storage device. With the application configuration information, the application system can resume the interrupted application operations after it recovers from a failure or after the storage device recovers from a failure.

Although an embodiment of the invention and its advantages are described in detail, a person skilled in the art could make various alternations, additions, and omissions without departing from the spirit and scope of the present invention as defined by the appended claims.

1-14. (canceled)

15. A system comprising:
a first storage device associated with a first mapping table; and
a physical resource, wherein the physical resource contains an application extension area, wherein the application extension area is associated with a logical resource, wherein the first mapping table contains mappings between the application extension area and physical segments of the physical resource, and wherein the first storage device stores application configuration information for the logical resource in the application extension area.

16. The system of claim 15, wherein the application extension area is divided into a segment composition area and an application area.

17. The system of claim 16, wherein the application configuration information is stored in the application area.

18. The system of claim 16, further comprising:
a second storage device containing a second mapping table, wherein, upon failure of the first storage device, the second storage device determines the second mapping table from the application extension area of the physical resource.

19. The system of claim 18, wherein the segment composition area stores a list of physical segments associated with the application extension area, wherein the physical resource contains a segment table that maps the location of the logical resource on the physical segments of the physical resource, and wherein the second storage device determines the second mapping table from the application extension area of the physical resource by (i) scanning the segment table of the physical resource to determine a set of physical segments that hold the application extension area, and (ii) reading the segment composition area to determine the application extension area for the logical resource.

20. A method, wherein a first storage device is associated with a physical resource and a first mapping table, wherein the physical resource includes an application extension area, and wherein the first mapping table maps a logical resource to the application extension area, the method comprising:
the first storage device receiving, from an application, a first access to the logical resource; and
in response to receiving the first access, the first storage device (i) using the first mapping table to map the first access to the application extension area, and (ii) storing configuration information of the application in the application extension area.

21. The method of claim 20, wherein the application extension area is divided into a segment composition area and an application area.

22. The method of claim 21, wherein the application area stores configuration information of the application.

23. The method of claim 21, wherein the segment composition area records the location and size of the logical resource as mapped to the physical resource.

24. The method of claim 23, wherein a second storage device backs up the first storage device, wherein the second storage device is associated with the physical resource and a second mapping table, and wherein the second mapping table maps between the logical resource and the application extension area, the method further comprising:
the first storage device failing; and
the second storage device determining the second mapping table from the application extension area.

25. The method of claim 24, wherein the physical resource comprises a segment table, and wherein determining the second mapping table from the application extension area comprises:
the second storage device scanning the segment table of the physical resource to determine a first set of physical segments of the physical resource that hold the application extension area; and
the second storage device reading the segment composition area of the application extension area to identify the application extension area for the logical resource.

26. The method of claim 25, further comprising:
the second storage device determining that there are no physical resources mapped to the application extension area of the logical resource; and
the second storage device determining the second mapping table from the segment composition area.

27. The method of claim 26, further comprising:
the second storage device receiving, from the application, a second access to the logical resource; and
in response to receiving the second access, the second storage device using the second mapping table to map the access to the application extension area.

28. The method of claim 25, further comprising:
the second storage device determining that there are physical resources mapped to the application extension area for the logical resource; and
the second storage device marking the application extension area for the logical resource as unavailable.

29. The method of claim 22, wherein the configuration information of the application includes execution progress of the application.

30. A method for configuring a storage device, wherein the storage device is associated with a physical resource and a mapping table, wherein the physical resource is divided into physical segments and uses a segment table to record information regarding each physical segment, the method comprising:
selecting a first set of physical segments in the segment table to use as a data area;
selecting a second set of physical segments in the segment table to use as an application extension area;
dividing the application extension area into a segment composition area and an application area;
storing a list of the first and second sets of physical segments in the segment composition area;
initializing the application area for storage of the application configuration information; and
updating the mapping table to map the data area and the application extension area to their respective sets of physical segments.

31. The method of claim 30, wherein the data area and the application extension area are associated with a logical resource.

32. The method of claim 31, wherein the mapping table maps the logical resource to the physical segments of the physical resource.

33. The method of claim 32, further comprising:
after updating the mapping table, receiving an access to the logical resource; and
using the mapping table to map the logical resource to the physical resource.

34. The method of claim 30, wherein the first set of physical segments are specified by one of a (i) user, and (ii) a pre-defined size.
